(19) United States
(12) Patent Application Publication
(10) Pub. No.: US 2009/0073484 A1
(43) Pub. Date: Mar. 19, 2009

(54) Hospitality Digital Photo Processing

(76) Inventor: Paul Harris, (US)

Correspondence Address: Paul Harris, 205 Commercial Court, Morganville, NJ, 07751, US

(21) Appl. No.: 11/855,023

(22) Filed: Sep. 13, 2007

(51) Int. Cl. G06K 15/00; G06K 1/00; H04N 7/173

(52) U.S. Cl. 358/1.15; 358/1.16; 725/104

(57) ABSTRACT

A process for providing printed photos from memory cards via network from a hotel room using a memory card reader, device to display photo(s), and a display. The on screen menu system of the photo viewer or PPV system allows for selection, processing, and billing of the photos.

The invention relates to the process of viewing digital photo content in hotel rooms for printing via network. Through the use of a memory card reader, a device to read in and display the photo(s), and an in room display, a user can select the photo(s) to be printed through services offered by the hotel.

The invention could carry out this process with a memory card reader connected to a device capable of reading the files on the memory card and displaying the photos on a display device. The digital photo files can be selected using an interface device like an IR Remote. When a photo is selected the on screen menu system can prompt a guest for size as well as the quantity of each digital photo to be printed. Upon completion the files are then transferred via network to a location that will process the photos for the guest to be picked up or delivered to their room. Hotels with PPV systems can use the menu system of the PPV to communicate with the photo viewer device for selection of the digital photo(s). In addition, the system can process the billing from the selection of photo(s) to be printed if desired. The supplied drawings demonstrate some methods to accomplish the effect of the invention.

Definition List 1

| Term | Definition |
|---|---|
| Memory Card | A memory card (sometimes called a flash |
| | memory card or a storage card) is a |
| | small storage medium used to store data |
| | such as text, pictures, audio, and video, |
| | for use on small, portable or remote |
| | computing devices. Most of the current |
| | products use flash memory, although |
| | other technologies are available. There |
| | are a number of memory cards on the |
| | market, including the SD card (secure |
| | digital card), the CF card (CompactFlash |
| | card), the SmartMedia card, the Memory |
| | Stick, and the MultiMediaCard (MMC). |
| | These cards are of varying sizes, and |
| | each is available in a range of storage |
| | capacities |
| Hotel | An establishment that provides lodging |
| | and other services for travelers and other |
| | paying guests. |
| PPV | Pay Per View provider |
| Digital Photo | A file from a digital camera or scanner |
| | which contains sets of numbers that |
| | specify the colors of a rectangular grid of |
| | pixels. A digital photo is invisible unless |
| | it is displayed or printed. |
| Display Device | A device which is capable of displaying |
| | video and/or graphic images. Examples |
| | of such a device might be CRT, Plasma, |
| | LCD, OLED, DLP Projection, LCD |
| | Projection, or any other technology |
| | capable of showing static or moving |
| | video/graphic images. |
| Photo Viewer | A device capable of reading file(s) |
| | containing digital photo information and |
| | allowing it to be viewed on a display |
| | device and also transfer the file(s) to |
| | another location via network. An |
| | example could be a PC or embedded |
| | system. |

### DESCRIPTION OF DRAWINGS

FIG. 1 is an example of a room with memory card reader connected to a photo viewer device which in turn is connected to a display device. The photo(s) is viewed on the display and using the on screen display the user selects the quantity and size of photos to be printed and purchased. The photo viewer is connected to a LAN to allow for the file(s) to be transferred to a location once the selections are confirmed. The file(s) are then received by the service provided by the hotel for printing.

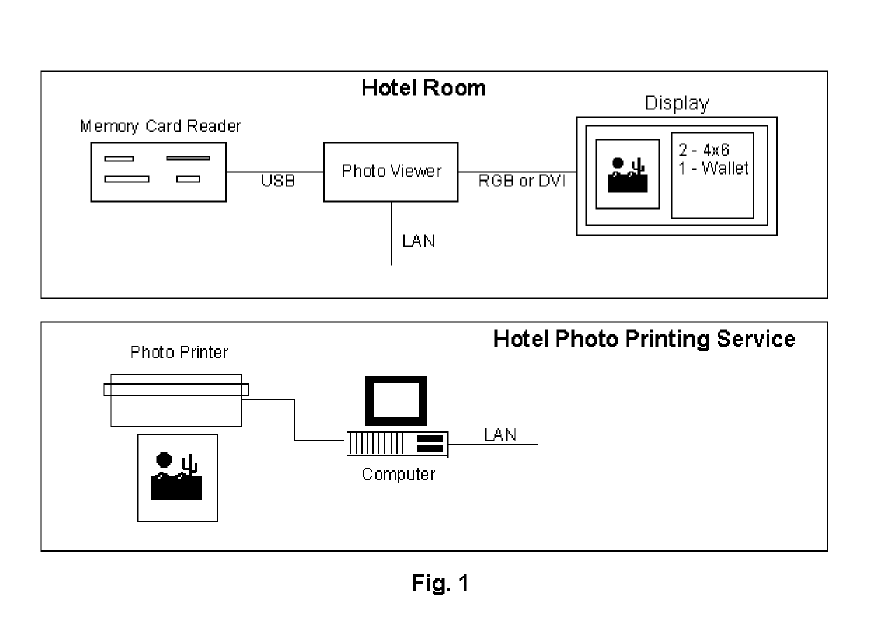

FIG. 2 is a card reader device connected to a photo viewer device which in turn is connected to a display device. The photo viewer is also connected to the PPV system for control of its menu selections. The photo viewer is connected to a LAN to allow for the file(s) to be transferred to a location once the selections are confirmed. The file(s) are then received by the service provided by the hotel for printing.

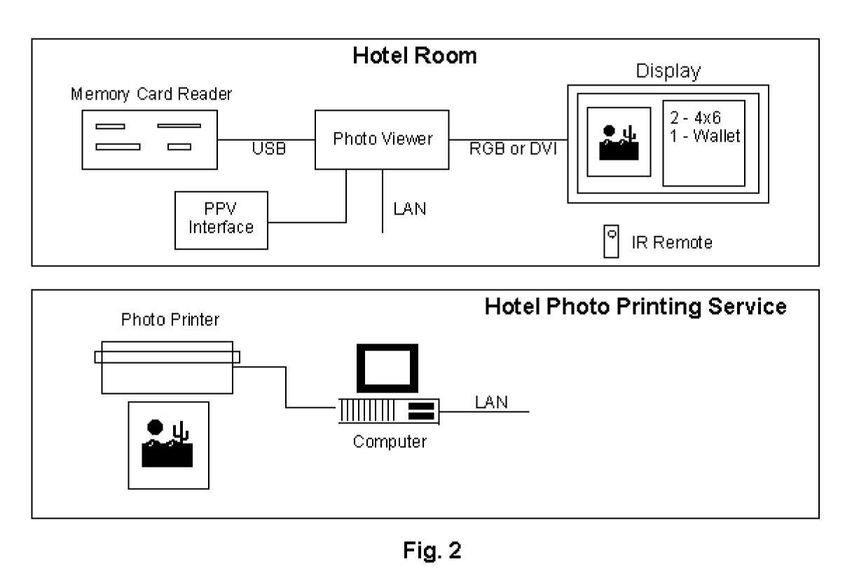

What is claimed is:

1. A process for viewing digital photo content in hotel rooms for printing via network through the use of a memory card reader, a device to read in and display the photo(s), and an in room display. The photo(s) are selected via on screen display then sent via network to be printed through services offered by the hotel.

2. The digital photo viewer of claim 1 whereby the Pay per View interface is in control of the photo viewer system.

3. The digital photo viewer system of claim 1 wherein a billing system for printing of digital photo(s) based on quantity and size is implemented.
